(19) United States
(12) Patent Application Publication
(10) Pub. No.: US 2019/0145556 A1
(43) Pub. Date: May 16, 2019

(54) PACKING MEMBER FOR SEALING A PIPE

(71) Applicant: Hi-Sten Co., Ltd., Gimhae-si (KR)

(72) Inventor: Kuk Jin KIM, Gyeongsangnam-do (KR)

(21) Appl. No.: 16/075,990

(22) PCT Filed: Mar. 12, 2017
(86) PCT No.: PCT/KR2017/004953

§ 371 Date: Aug. 7, 2018

(51) Int. Cl. F16L 17/035

(52) U.S. Cl. CPC F16L 17/035

(57) ABSTRACT

The present invention relates to a packing member for sealing a pipe which is configured to have a hollow shape inserted into a hollow housing and is configured to accommodate a pipe in the inner hollow hole thereof so as to block fluid flowing in the pipe from leaking out and more specifically, to a packing member for sealing a pipe including a curved part configured to protrude from both ends of a hollow body towards the inner center of the body, a fluid accommodating unit formed between the curved part and the inner surface of the body and configured to accommodate fluid, and a first flow channel hole formed at an end portion of the curved part and connected to the fluid accommodating unit so as to introduce fluid into the fluid accommodating unit even when the end portion of the curved part contacts the inner surface of the body by means of the pipe inserted into the body.

As described above, a packaging member for sealing a pipe of the present invention has a fluid accommodating unit for accommodating fluid that leaks in an early stage so as to completely prevent fluid leakage. Additionally, when the fluid that leaks in an early stage is accommodated in the fluid accommodating unit, fluid pressure increases and the pipe is sealed more efficiently thereby preventing continuous leakage of fluid. Further, a packaging member for sealing a pipe of the present invention has a significant advantage of sealing the pipe more efficiently etc. by means of accommodating units provided on both ends of a packing.

### TECHNICAL FIELD

The present invention relates to a packing member for sealing a pipe which is configured to have a hollow shape inserted into a hollow housing and is configured to accommodate a pipe in the inner hollow hole thereof so as to block fluid flowing in the pipe from leaking out and more specifically, to a packing member for sealing a pipe including a curved part configured to protrude from both ends of a hollow body towards the inner center of the body, a fluid accommodating unit formed between the curved part and the inner surface of the body and configured to accommodate fluid, and a first flow channel hole formed at an end portion of the curved part and connected to the fluid accommodating unit so as to introduce fluid into the fluid accommodating unit even when the end portion of the curved part contacts the inner surface of the body by means of the pipe inserted into the body.

### DESCRIPTION OF THE RELATED ART

In general, a packing member is manufactured from a synthetic rubber or a synthetic resin and is used to couple a pipe to a pipe and to prevent fluid from leaking out of a valve.

As a related art, Patent Publication No. 10-0974605 discloses a packing for connecting pipes, which is configured as a ring-shaped packing for connecting pipes and interposed between a female pipe and a male pipe so as to seal the pipes, includes a plurality of ring-groove parts formed at the inner circumferential surface of the packing and sporadically severed along the circumferential direction, a plurality of ring-surface parts formed between the ring-groove parts, consisting of the same surface as the inner circumferential surface of the packing, and having a certain length, wherein the plurality of ring-surface parts are formed at regular intervals along the ring-groove part with respect to the entire circumferential direction, the plurality of ring-groove parts are spaced apart from each other at regular intervals along the axis of the packing, and the ring-surface parts adjacent to each other are arranged in the form of a zigzag.

As another related art, Korean Utility Model Publication No. 20-0425952 discloses a packing for sealing underground pipes, which is installed at the end of one side of a pair of underground pipes and is inserted and installed between a pair of connecting pipes whose outer circumferential surface is connected by a connecting joint, includes a circular ring-shaped coupling part which is inserted into and installed on one lateral surface of any one selected from the pair of connecting pipes and whose cross section has an arrow shape; a circular ring-shaped outer sealing part which is positioned at one end of one side of the coupling part and whose cross section has a rectangular shape; a circular ring-shaped inner sealing part which is positioned inside the outer sealing part and whose cross section has a rectangular shape with a width smaller than that of the outer sealing part; and a sealing sill which is positioned inside the inner sealing part and whose cross section has a reversed “V”.

Conventional packing members come in different shapes so as to prevent fluid from leaking out of a pipe. However, once a pipe leaks, the amount of leaked fluid increases over time. Accordingly, the packing can no longer work correctly.

### DETAILED DESCRIPTION OF THE INVENTION

### Technical Problems

As a means to solve the above-described problems, provided is a packing member for sealing a pipe which includes a fluid accommodating unit that accommodates fluid leaking out of a pipe, so as to seal the pipe more efficiently when the fluid leaks out of the pipe in an early stage.

### Technical Solutions

A packing member for sealing a pipe, which is configured to have a hollow shape inserted into a hollow housing and is configured to accommodate a pipe in the inner hollow hole thereof so as to block fluid flowing in the pipe from leaking out, includes a curved part configured to protrude from both ends of a hollow body towards the inner center of the body, a fluid accommodating unit formed between the curved part and the inner surface of the body and configured to accommodate fluid, and a first flow channel hole formed at an end portion of the curved part and connected to the fluid accommodating unit so as to introduce fluid into the fluid accommodating unit even when the end portion of the curved part contacts the inner surface of the body by means of the pipe inserted into the body.

### Advantageous Effects

As described above, a packaging member for sealing a pipe of the present invention has a fluid accommodating unit for accommodating fluid that leaks in an early stage, so as to completely prevent fluid leakage. Additionally, when the fluid that leaks in an early stage is accommodated in the fluid accommodating unit, fluid pressure increases and the pipe is sealed more efficiently thereby preventing fluid leakage. Further, a packaging member for sealing a pipe of the present invention has a significant advantage of sealing the pipe more efficiently by means of the accommodating units provided on both ends of a packing.

### BRIEF DESCRIPTION OF THE INVENTION

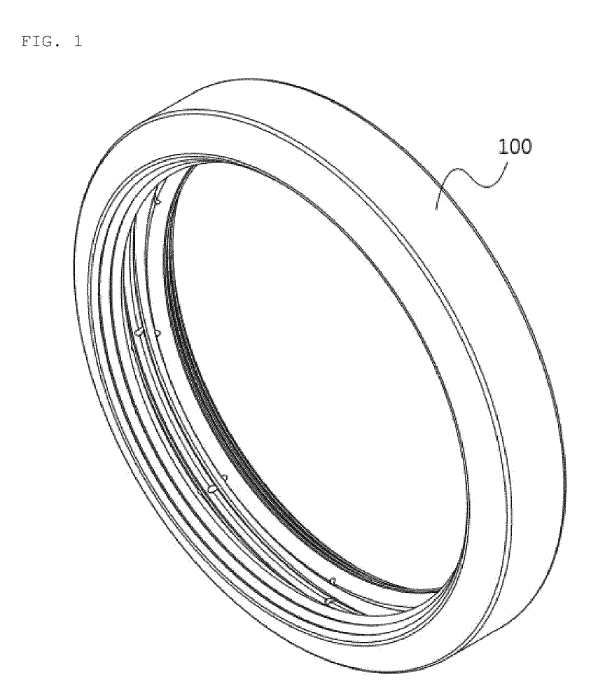

FIG. 1 is a perspective view illustrating a packing member for sealing a pipe of the present invention.

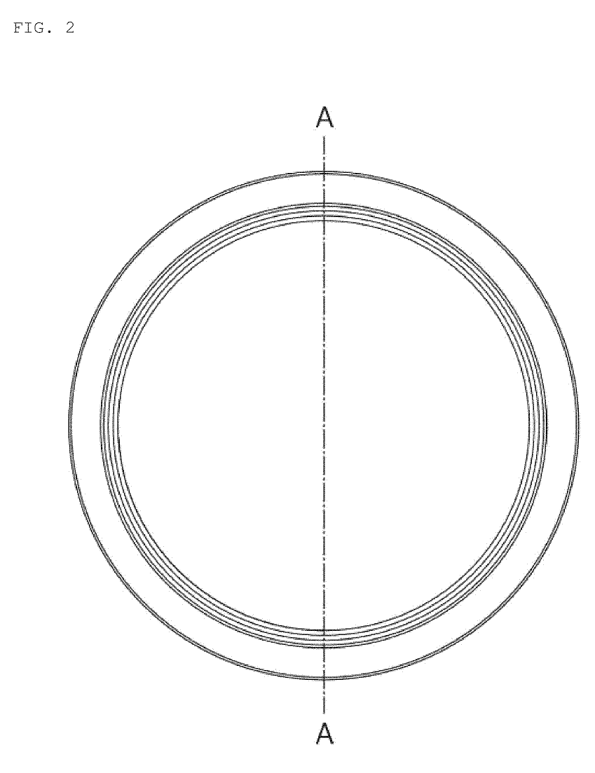

FIG. 2 is a front view illustrating a packing member for sealing a pipe of the present invention.

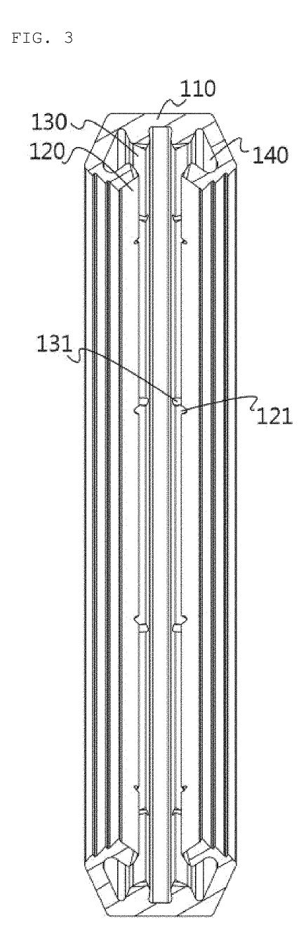

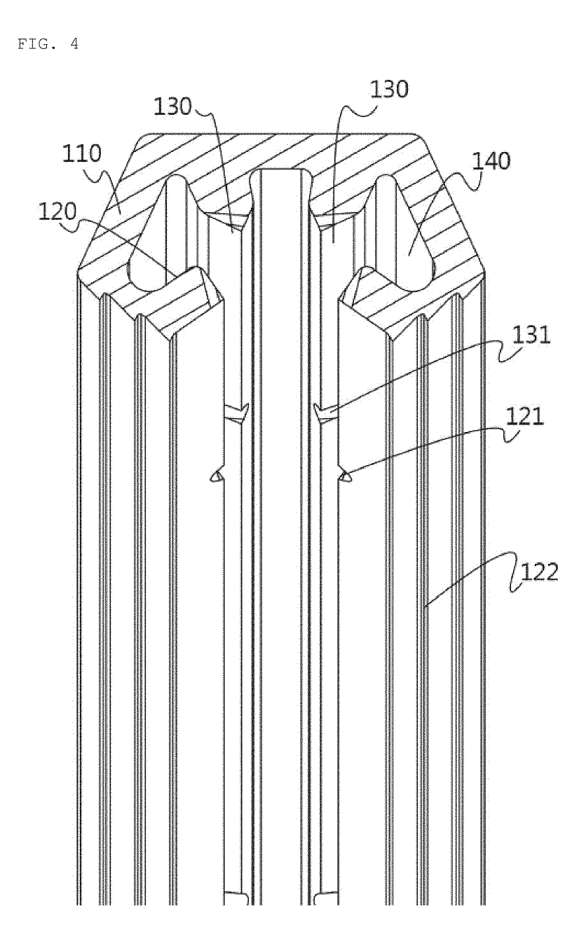

FIG. 3 is a vertical cross section illustrating a packing member for sealing a pipe of the present invention. FIG. 4 is an enlarged cross section illustrating a part of a packing member for sealing a pipe of the present invention.

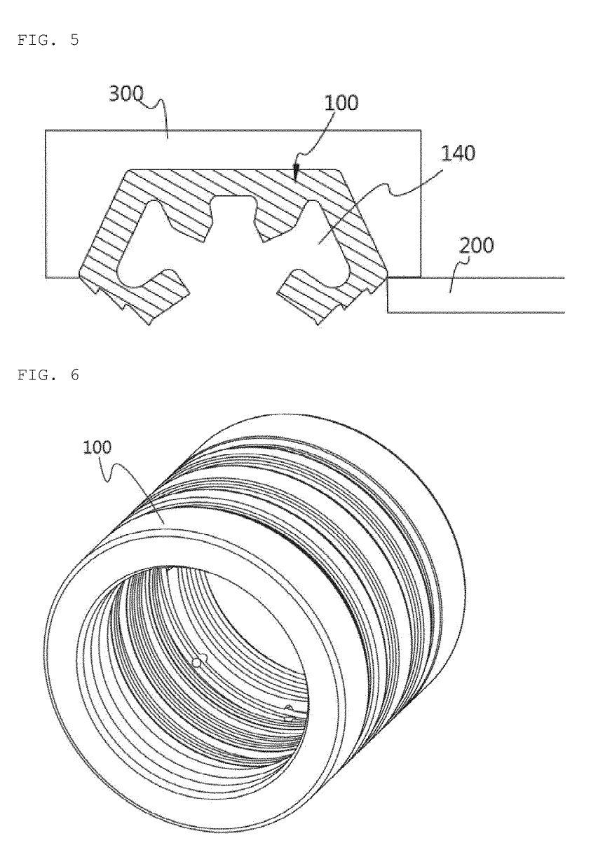

FIG. 5 is a view illustrating a state where sealing is carried by means of a packing member for sealing a pipe of the present invention.

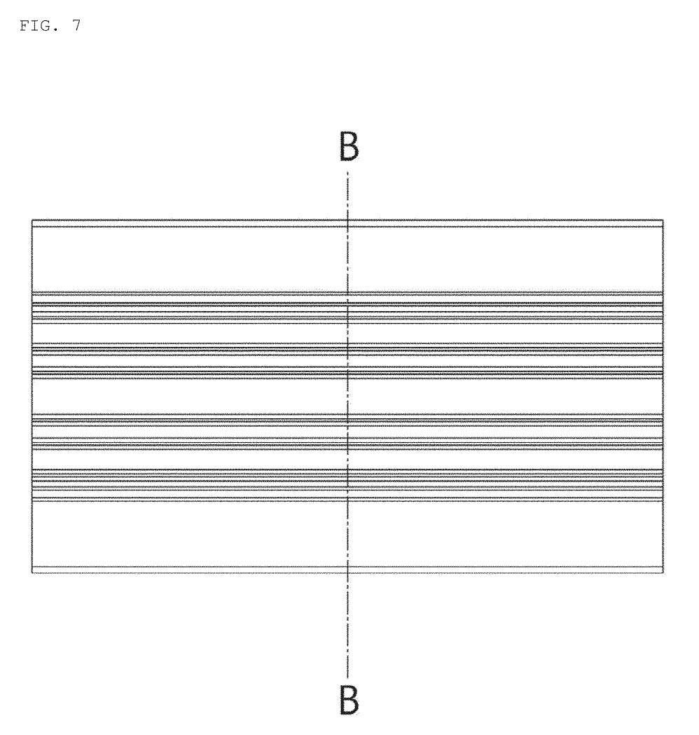

FIG. 6 is a perspective view according to another embodiment of a packing member for sealing a pipe of the present invention.

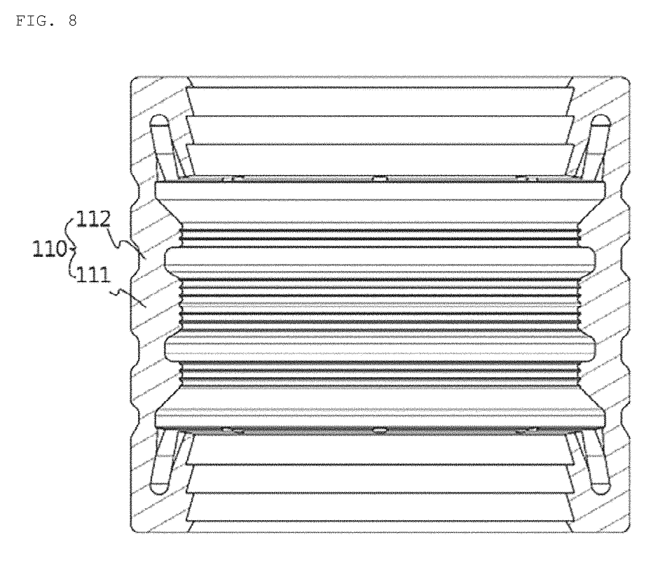

FIG. 7 is a plan view according to another embodiment of a packing member for sealing a pipe of the present invention.

FIG. 8 is a vertical cross section according to another embodiment of a packing member for sealing a pipe of the present invention.

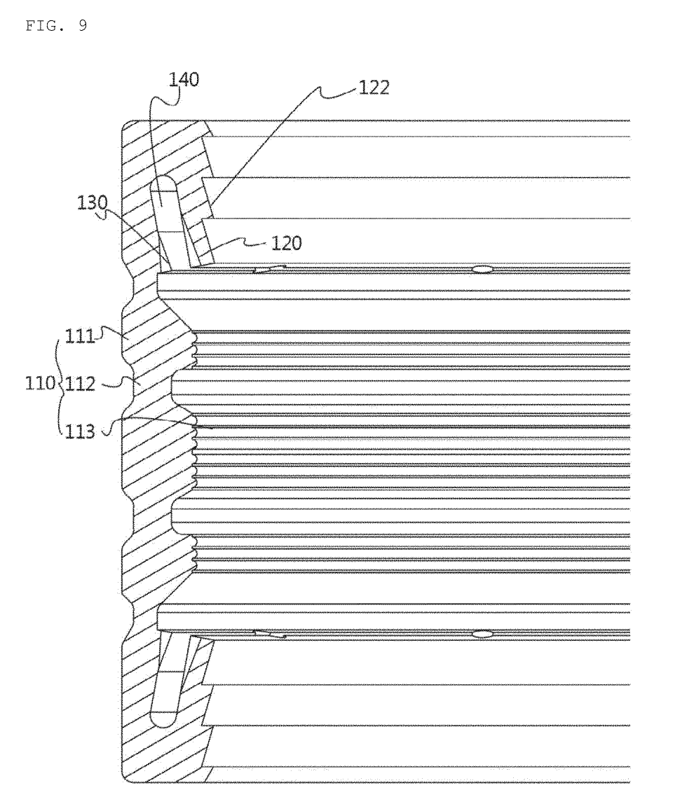

FIG. 9 is an enlarged cross section of a part of a packing member for sealing a pipe of the present invention according to another embodiment of the present invention.

### DESCRIPTION OF THE SYMBOLS

100. Packing member
110. Body 111. First body 112. Second body
113. Corrugated part
120. Curved part 121. First flow channel hole
122. Step
130. Protruding sill 131. Second flow channel hole
140. Fluid accommodating unit
200. Pipe
300. Housing

### BEST MODE FOR CARRYING OUT THE INVENTION

A packing member for sealing a pipe 100, which is configured to have a hollow shape inserted into a hollow housing 300 and is configured to accommodate a pipe 200 in the inner hollow hole thereof so as to block fluid flowing in the pipe 200 from leaking out, includes a curved part 120 configured to protrude from both ends of a hollow body 110 towards the inner center of the body 110, a fluid accommodating unit 140 formed between the curved part 120 and the inner surface of the body 110 and configured to accommodate fluid, and a first flow channel hole 121 formed at an end portion of the curved part 120 and connected to the fluid accommodating unit 140 so as to introduce fluid into the fluid accommodating unit 140 even when the end portion of the curved part 120 contacts the inner surface of the body by means of the pipe 200 inserted into the body 110.

If fluid flowing inside the pipe 200 leaks and then is introduced into the fluid accommodating unit 140 through the first flow channel hole 121, the curved part 120 firmly comes into close contact with the outer surface of the pipe 200 by means of fluid pressure inside the fluid accommodating unit 140 such that the pipe 200 is sealed.

Additionally, the first flow channel hole 121 of the curved part 120 is configured to have a half circle shape, a protruding sill 130 is formed on the inner surface of the body 110 the curved part 120 contacts and protrudes inwards, a second flow channel hole 131 is configured to have a half circle shape so as to correspond to the first flow channel hole 121 of the curved part 120 and is formed at the protruding sill 130 such that the first flow channel hole 121 and the second flow channel hole 131 form a circle shape when the end portion of the curved part 120 contacts the protruding sill 130 by means of the pipe 200 inserted into the body.

Further, a plurality of the first flow channel holes 121 and the second flow channel holes 131 are spaced apart at a regular interval along the circumferential direction of the curved part 120 and protruding sill 130.

Further, a step 122 is formed on the outer surface where the curved part 120 contacts the pipe 200.

Below, a packing member for sealing a pipe of the present invention will be described in detail with reference to the attached drawings.

FIG. 1 is a perspective view illustrating a packing member for sealing a pipe of the present invention, FIG. 2 is a front view illustrating a packing member for sealing a pipe of the present invention, FIG. 3 is a vertical cross section illustrating a packing member for sealing a pipe of the present invention, and FIG. 4 is an enlarged cross section illustrating a part of a packing member for sealing a pipe of the present invention.

For reference, FIG. 3 is a sectional view illustrating a packing member for sealing a pipe cut along the line A-A in FIG. 2, and FIG. 4 is an enlarged cross section illustrating a part of the packing member for sealing a pipe in FIG. 3.

The present invention, as illustrated in FIGS. 1 to 4, relates to a packing member for sealing a pipe 100 which is configured to have a hollow shape inserted into a hollow housing 300 and is configured to accommodate a pipe 200 in the inner hollow hole thereof so as to block fluid flowing in the pipe 200 from leaking out.

Specifically, a packing member 100 of the present invention includes a curved part 120 configured to protrude from both ends of a hollow body 110 towards the inner center of the body 110, and a fluid accommodating unit 140 formed between the curved part 120 and the inner surface of the body 110 and configured to accommodate fluid.

That is, one end of the curved part 120 is integrally formed at an end portion of the body 110 while the other end is curved towards the center of the body 110, and a space is formed between the curved part 120 and the inner surface of the body 110 so as to accommodate fluid leaking out of the pipe 200. The space is referred to as a fluid accommodating unit 140.

In this case, a first flow channel hole 121 is formed at an end portion of the curved part 120 and connected to the fluid accommodating unit 140 so as to introduce fluid into the fluid accommodating unit 140 even when the end portion of the curved part 120 contacts the inner surface of the body by means of the pipe 200 inserted into the body 110.

Meanwhile, the first flow channel hole 121 of the curved part 120 is configured to have a half circle shape, a protruding sill 130 is formed on the inner surface of the body 110 the curved part 120 contacts and protrudes inwards, a second flow channel hole 131 is configured to have a half circle shape so as to correspond to the first flow channel hole 121 of the curved part 120 and is formed at the protruding sill 130.

Accordingly, the first flow channel hole 121 and the second flow channel hole 131 form a circle shape when the end portion of the curved part 120 contacts the protruding sill 130 by means of the pipe 200 inserted into the body.

Additionally, a plurality of the first flow channel holes 121 and the second flow channel holes 131 are spaced apart at a regular interval along the circumferential direction of the curved part 120 and protruding sill 130 so as to easily introduce fluid into the fluid accommodating unit 140.

Further, a plurality of steps 122 are formed on the outer surface where the curved part 120 contacts the pipe 200, and are configured to incline towards the inner circumferential center of the packing member 100 such that the curved part 120 is blocked from folding outwards when the pipe 200 is inserted.

A packing member 100 of the present invention is preferably manufactured from a synthetic rubber or a synthetic resin.

FIG. 5 is a view illustrating a state where sealing is carried out by means of a packing member for sealing a pipe of the present invention.

As illustrated in FIG. 5, by means of a packing member 100 with the above-described configuration, if fluid flowing inside the pipe 200 leaks and then is introduced into the fluid accommodating unit 140 through the first flow channel hole 121, the curved part 120 firmly comes into close contact with the outer surface of the pipe 200 by means of fluid pressure inside the fluid accommodating unit 140 such that the pipe 200 is sealed.

FIG. 6 is a perspective view according to another embodiment of a packing member for sealing a pipe of the present invention, FIG. 7 is a plan view according to another embodiment of a packing member for sealing a pipe of the present invention, FIG. 8 is a vertical cross section according to another embodiment of a packing member for sealing a pipe of the present invention, and FIG. 9 is an enlarged cross section of a part of a packing member for sealing a pipe of the present invention according to another embodiment of the present invention.

For reference, FIG. 8 is a sectional view illustrating a packing member for sealing a pipe cut along the line B-B in FIG. 7, and FIG. 9 is an enlarged cross section illustrating a part of the packing member for sealing a pipe in FIG. 8.

As illustrated in FIGS. 6 to 8, if the diameter of the pipe 200 is large, a large-sized packing member 100 is needed, and if a packing member 100 is large in size, it means the length between both end portions where the curved part 120 is formed—i.e. the length of the body 110—is lengthened. Accordingly, the packing member is less efficient.

Against these circumstances, the body 110 forms a first body 111 and a second body 112 having a width smaller than that of the first body 111 one after another, and a corrugated part 113 is formed on the inner surface of the first body 111, so as to withstand fluid pressure that happens when fluid leaks out of the pipe 200.

As described above, a packaging member for sealing a pipe of the present invention has a fluid accommodating unit for accommodating fluid that leaks in an early stage so as to completely prevent fluid leakage. Additionally, when the fluid that leaks in an early stage is accommodated in the fluid accommodating unit, fluid pressure increases and the pipe is sealed more efficiently thereby preventing fluid leakage. Further, a packaging member for sealing a pipe of the present invention has a significant advantage of sealing the pipe more efficiently by means of the fluid accommodating units provided on both ends of a packing.

What is claimed is:

1. A packing member for sealing a pipe configured to have a hollow shape inserted into a hollow housing (300) and configured to accommodate a pipe (200) in the inner hollow hole thereof so as to block fluid flowing in the pipe (200) from leaking out,
wherein the packing member (100) comprises a curved part (120) configured to protrude from both ends of a hollow body (110) towards the inner center of the body (110), a fluid accommodating unit (140) formed between the curved part (120) and the inner surface of the body (110) and configured to accommodate fluid, and a first flow channel hole (121) formed at an end portion of the curved part (120) and connected to the fluid accommodating unit (140) so as to introduce fluid into the fluid accommodating unit (140) even when the end portion of the curved part (120) contacts the inner surface of the body (110) by means of the pipe (200) inserted into the body (110),
the first flow channel hole (121) of the curved part (120) is configured to have a half circle shape, a protruding sill (130) is formed on the inner surface of the body (110) the curved part (120) contacts and protrudes inwards, and a second flow channel hole (131) is configured to have a half circle shape so as to correspond to the first flow channel hole (121) of the curved part (120) and is formed at the protruding sill (130) such that the first flow channel hole (121) and the second flow channel hole (131) form a circle shape when the end portion of the curved part (120) contacts the protruding sill (130) by means of the pipe (200) inserted into the body,
a plurality of the first flow channel holes (121) and the second flow channel holes (131) are spaced apart at a regular interval along the circumferential direction of the curved part (120) and protruding sill (130), a plurality of steps (122) are formed on the outer surface of the curved part (120) which contacts the pipe (200) and are configured to incline towards the inner center of the packing member (100) such that the curved part (120) is blocked from folding outwards when the pipe (200) is inserted, and the curved part (120) firmly comes into close contact with the outer surface of the pipe (200) by means of fluid pressure inside the fluid accommodating unit (140) such that the pipe (200) is sealed if fluid flowing inside the pipe (200) leaks and then is introduced into the fluid accommodating unit (140) through the first flow channel hole (121),
the body (110) forms a first body (111) and a second body (112) having a width smaller than that of the first body (111) one after another, and a corrugated part (113) is formed on the inner surface of the first body (111), so as to withstand fluid pressure that happens when fluid leaks out of the pipe (200).
